(19) United States
(12) Patent Application Publication
(10) Pub. No.: US 2016/0086152 A1
(43) Pub. Date: Mar. 24, 2016

(54) Mobile Application for the Easy and Quick Exchange of Money

(71) Applicant: Ashley SHILKIN, Los Angeles, CA (US)

(72) Inventor: Ashley Shilkin, Los Angeles, CA (US)

(21) Appl. No.: 14/787,629

(22) PCT Filed: May 13, 2014
(86) PCT No.: PCT/US14/37836

§ 371 Date: Oct. 28, 2015

Related U.S. Application Data
(60) Provisional application No. 61/822,910, filed on May 13, 2013.

(51) Int. Cl. G06Q 20/32

(52) U.S. Cl. CPC G06Q 20/32

(57) ABSTRACT

A system and method is provided in the form of an application that includes means for permitting a user to establish a user account via a registration process, where the user account is configured to be dynamically funded at select or periodic intervals by the user from one of a number of possible funding sources. The system and method further includes means for associating one or more separate accounts with the registered user account, and also means for directing a transfer of money to an outside account either directly from the registered user account or directly from one or more of the separate accounts, permitting the user to by-pass the registered user account if so desired.

### CORRESPONDING PATENT APPLICATION

The present application takes priority from provisional application U.S. Ser. No. 61/822,910 filed May 13, 2013, the entire contents of which are incorporated herein in its entirety by reference.

### BACKGROUND

The embodiments herein relate generally to a system and method for facilitating the transfer of money from one account to another using mobile and web-based applications, and specifically to embodiments that may be employed entirely as a mobile device application without need of relying upon web-based functionality. Existing services provide money exchange functionality, but in every case they are either limited in the features offered to broadly expand and control the exchange of funds, or require a user to interface with a web-based software program as part of the process of establishing an account or exchanging funds. Embodiments of the present invention address those limitations by creating an entirely mobile-device-based application to carry out all functionality, including appropriate safeguards and securities features, to permit users to exchange funds.

### SUMMARY

In some embodiments of the present invention, a system is provided comprising an application that is either configured to be downloadable to a mobile device, configured as a web-based program accessible through the Internet, and/or configured as a software program installable on a computer, the system further configured to permit the exchange of money by a user between a user account and an account outside the system. In some embodiments, the system comprises means for permitting a user to establish the user account via a registration process, where the user account is configured to be dynamically funded at select or periodic intervals by the user from one of a number of possible funding sources; means for associating one or more separate accounts with the registered user account; and means for directing a transfer of money to an outside account either directly from the registered user account or directly from one or more of the separate accounts, permitting the user to by-pass the registered user account if so desired. In some cases, the system comprises only a downloadable application configured to be downloaded and fully controlled from a user's mobile device to permit full functionality without the need for the user to use a separate computer-based software program or web-based application. In other cases, the system comprises only a web-based program accessible by users through the Internet. With respect to many embodiments of the present invention, the separate account comprises one of the following types of accounts: a credit card, a debit card, a bank account, an investment account, or an operator billing account. Likewise, the registered user account may be automatically associated with a 16-digit debit card generated by the system and sent to the user so that the user may use the debit card to pay for things based upon the funds available in the system account. In some embodiments, the system may further comprise means for tailoring the graphics of the debit card by adding one or more photos and other personal information. In some embodiments, the system further comprises means for communicating with the holder of the outside account that an exchange of money has been made, the method of communication comprising one of a number of digital formats, including text, email or the like.

In some embodiments of the present invention, a method is provided for the exchange of money between a user account and an outside account, the method comprising permitting a user to establish the user account via a registration process, where the user account is configured to be dynamically funded at select or periodic intervals by the user from one of a number of possible funding sources; associating one or more separate accounts with the registered user account; and directing a transfer of money to an outside account either directly from the registered user account or directly from one or more of the separate accounts, permitting the user to by-pass the registered user account if so desired. In some embodiments, the registration, association of one or more separate accounts, and the directing of a transfer of money are entirely performed on the user's mobile device.

### BRIEF DESCRIPTION OF THE FIGURES

FIGS. 1-31 show a series of pictorial examples of graphic user interface windows presentable to users that are employed within certain embodiments of the inventive money exchange applications described herein, where in the examples of windows are those that might be used on a mobile device in carrying out the methodologies contemplated by the invention.

### DETAILED DESCRIPTION OF CERTAIN EMBODIMENTS

The term mobile device is broadly used and would be broadly understood by persons of ordinary skill in the art to refer to any computerized device that is transportable and can be used while in transport, including smart phones, tablets, laptops, smart watches, by example only. Moreover, although embodiments of the present invention may advantageously be used on mobile devices, they may also be used on less portable computerized devices, such as a desk top computer, for example. Indeed, in some embodiments, the type of computerized device used by a person to carry out the transactions described herein may rely partially or entirely upon a web-based application accessible through the Internet or private network.

In certain embodiments of the invention, a downloadable application is provided by a service provider, where the application that may be downloaded to a user's mobile device, presenting an icon for one-touch access to a system for easily transferring funds between accounts, including accounts owned by different persons. So, for example, using only one's mobile device, a user may set up a pre-paid personal fund-exchange account using the downloadable application. It is also contemplated that embodiments of the application may be entirely web-based accessible through the Internet, or in the form of a software program installable on a computer or one type or another (desktop, laptop, notebook, tablet, etc.). Indeed, embodiments of the present invention may be combinations of two of those configurations, or a combination of all three. So for example, a user may install a program on one's computer that is configured to interface through the Internet to a compatible web-based application and is also configured to synchronize with the user's mobile device or devices. Using one or more of these vehicles, a single personal fund-exchange account may be established, where the transfer of funds from the account may be carried out through the mobile device, the computer or via the web-based application. Importantly, at least some of the embodiments contemplated herein provide full functionality through use of only a downloadable application on a user's mobile device.

Funding of the personal fund-exchange account may be made from one of a number of possible sources. For example, the account may be funded by taking cash into a retail outlet that is part of a MasterCard® RePower™ network or the like. With such programs, a user may provide a certain amount of cash over the counter to a clerk with the ability to apply the cash through the MasterCard® RePower™ network or the like, where the personal fund-exchange account may be funded within minutes. Another source would be a user's bank account linked to the personal fund-exchange account, where the user can establish the link by providing details of the bank account, where embodiments of the application are configured to then withdraw money from the bank account and place it into the personal fund-exchange account. In some embodiments, initial set up may involve the application embodiment making one or more micro deposits into the personal fund-exchange account to initiate a successful pathway for funding. From that point, the user may make more significant transfers to fund the personal fund-exchange account to a greater amount desired. Yet another contemplated source would be through the association of a separate account, as described in much greater detail below. Some embodiments are configured to permit funding by the register user's personal fund-exchange account being configured to receive a transfer of money from the account of another user of the inventive application.

As alluded to above, the user may also associate one or more additional accounts with their personal fund-exchange account, and with the click or touch of a few icons, transfer money directly from their personal fund-exchange account, or directly from one or more of their other associated accounts, to someone else's account in virtually an instant. The actual exchange of funds, as directed by the user through the functionality of the application, is carried out seamlessly behind the scenes by the service provider of the downloadable application as well as by the institutions, both private and governmental, associated with the service provider that carry out the transaction. Those institutions and the service provider itself need not be known by the user to effectuate transfers of funds, although of course one would expect personal customer service to play a role to assist users as needed to utilize the applications contemplated herein.

In one embodiment of a downloadable application, an icon may be visible on the desktop of a mobile device, permitting a mobile device user to access the application by clicking or touching on the icon. It should be noted that references to “clicking” and to “icons” are general references to a user's being presented with a graphic interface that permits the user to, via clicking or touching with a finger or stylus, access a separate window, screen, or pop-up, or to execute instructions, with the icon being graphical or textual in nature and permitting a linked to be followed or instructions to be carried out.

In that regard, embodiments of the invention herein are similar to other downloadable applications to the extent that a desktop icon is provided as a vehicle for access to the application functionality. But the specific functionality permitted by the inventive embodiments herein are unique and advantageous when compared to competing services employed by others in the exchange of funds between accounts, as will be appreciated by the description below.

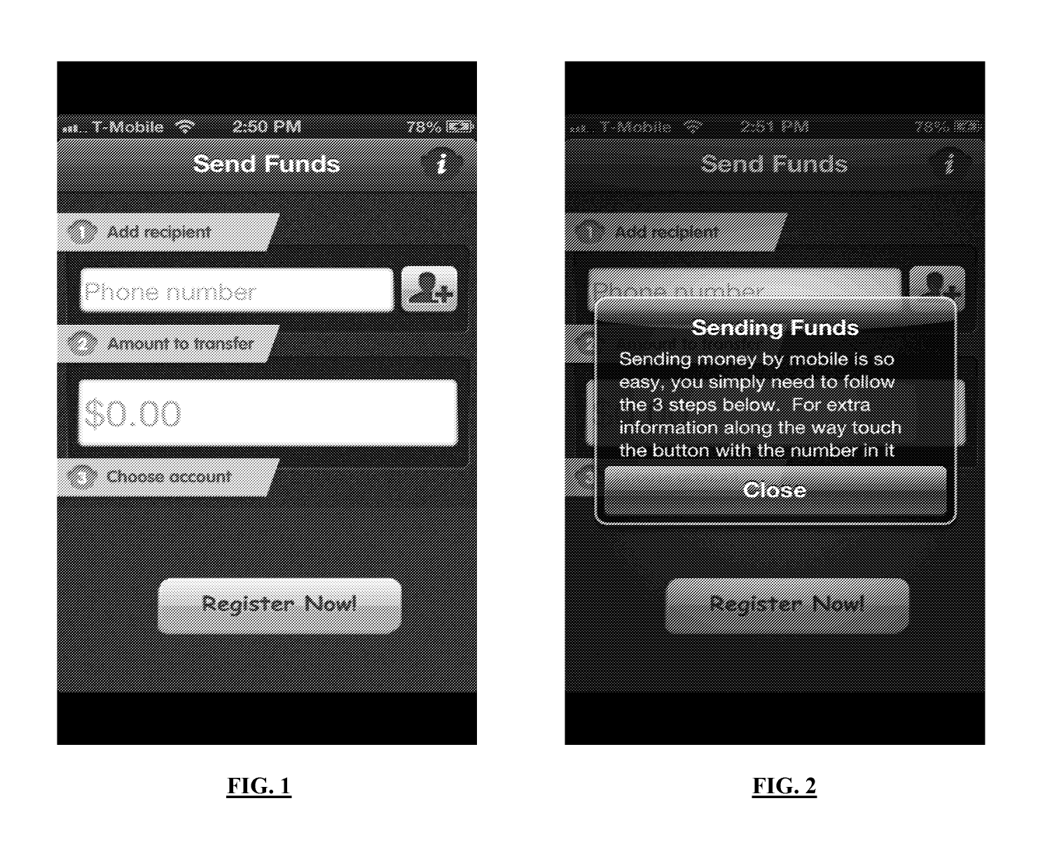

It is anticipated that effective operation of embodiments of the invention applications herein would comprise an initial registration process to permit a user to establish at least one account from which funds may be transferred. Upon clicking the icon, a screen as shown in FIG. 1 by example may be displayed to being the registration process. It should be noted that the figures described below are merely examples of what may be a wide variety of possible graphic interfaces, varying in configuration, style, aesthetics and functionality. In other words, more or less information may be provided on each screen depending upon the embodiment, more or less functionality may be provided on each screen depending upon the embodiment, and it is further contemplated that a certain amount of personal configuration may be provided with the applications to accommodate the personal tastes of the user. For purposes of context, however, the figures will be described as illustrating just one example of how the inventive application might function to permit an exchange of funds.

Referring to FIG. 1, one embodiment of the present system comprises a link to permit a user to register with the service provider to establish a personal fund-exchange account. It is contemplated that several if not all of the interface screens may include informational icons to assist the user through whatever functional process is desired at the moment, whether it is registration, the addition or deactivation of new accounts, the transfer of funds, the generation of reports and or receipts of transactions, and/or the communication of such reports and receipts to others or to one's self. In that regard, FIG. 2 shows one example of a hover screen that might appear to explain certain functionality if a user presses one of a plurality of icons visible on many of the screens. In this particular case, for example, the icon labeled “(i)” on the top right hand side of screen of FIG. 1, when clicked, would generate the hover screen shown in FIG. 2, where the hover screen is displayed in semi-transparent format over the original screen of FIG. 1.

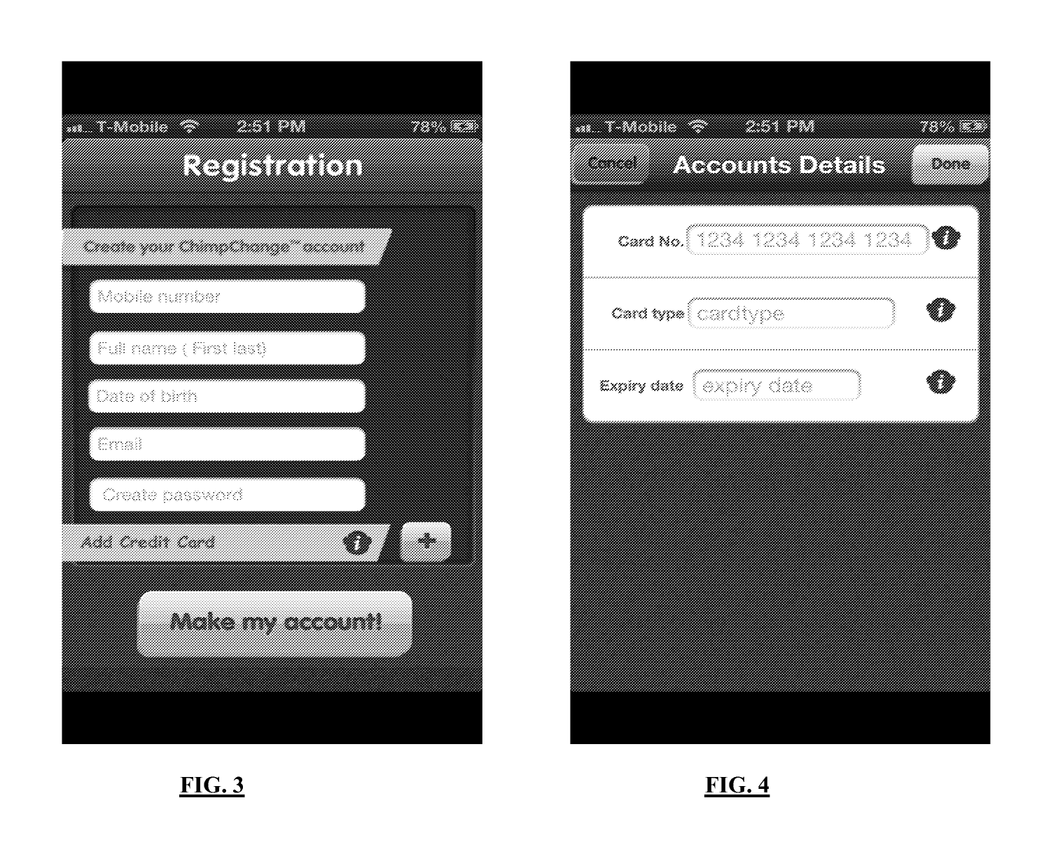

By returning to the screen of FIG. 1, and clicking on the “Register Now” icon, another screen appears entitled, for example, Registration, as shown in FIG. 3. Such a screen would display a number of metrics permitting a user to populate discrete windows with information about themselves as part of the registration process. In the case of the example of FIG. 3, the user could create a personal account, reflected by the icon “Create your ChimpChange™ account”, or could associate one or more account, as reflected by the icon “Add Credit Card,” where the use of the term “Credit Card” is purely by example. It should be understood that references to adding (or associating) “other accounts” below, whether a credit card or otherwise, is intended to broadly refer to any one or more of a number of types of accounts, including institutional accounts, such as credit card accounts, debit card accounts, bank accounts, investment accounts, and/or essentially any other type account from which the user has the ability to charge against the account, and/or make electronic withdrawals from the account. Indeed, it is contemplated that operator billing features could be included in embodiments of the inventive applications, whereby the user associates a cell phone service account with the personal fund-exchange account. Thus, one beneficial feature of embodiments of the present invention is the ability to associate with the personal fund-exchange account one or more of any number of types of accounts. Thus, while reference is made to a credit card account in the embodiments described herein, the invention is not limited to associating only credit card accounts with the fund-exchange account, but should be broadly interpreted to cover all types of accounts from which funds may be withdrawn or charged against.

It should be noted that the fanciful name ChimpChange™ is an example of a trademark that might be used by a service provider of the inventive applications described herein. Because the screen shots were created with the intention of using that trademark, the reader will see that trademark on several of the screens illustrated in the Figures. Of course, embodiments of the invention need not use any trademark on the screens, but it may be desirable for service providers to do so from a marketing and good will standpoint.

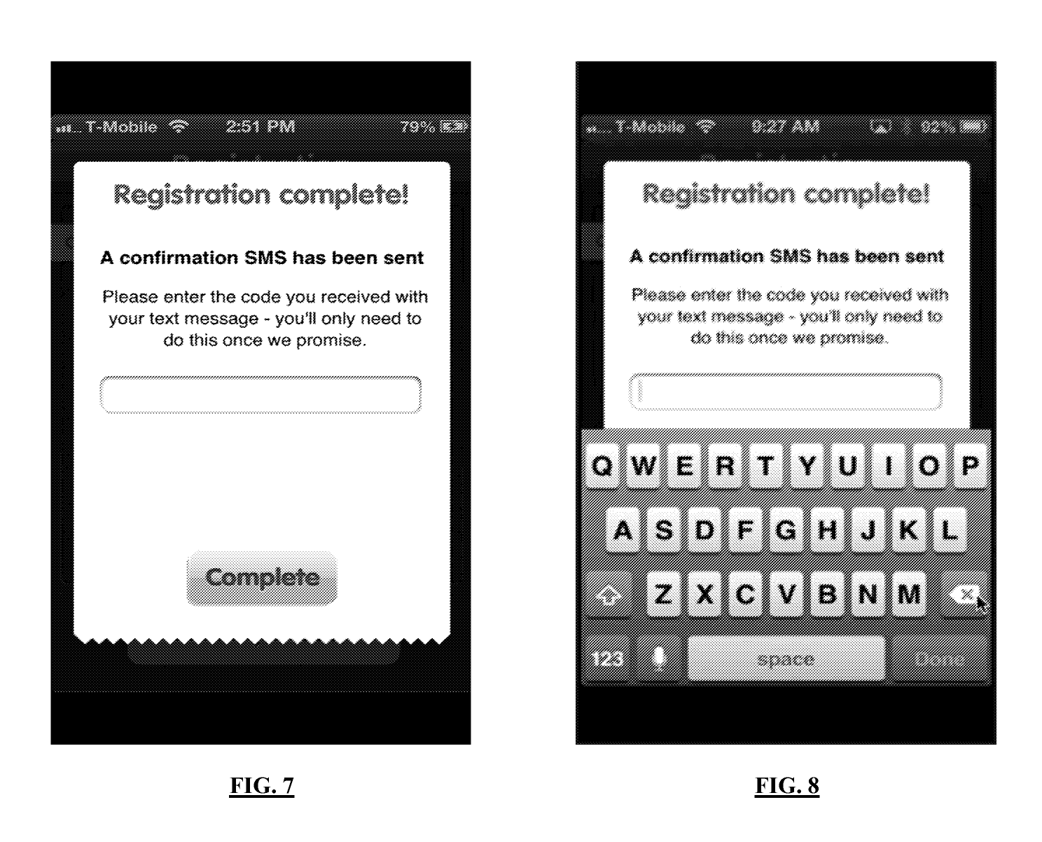

Still referring to FIG. 3, once the personal information is populated under the “Create . . . account” icon, the user may go directly to creating a personal fund-exchange account by clicking on the icon marked for example “Make my account!” If the user chooses to do so, it could in one example bring up a screen such as the one shown in FIG. 7, in which acknowledgement of the completion of registration is made. One example of a security feature that may be employed is the requirement that a code be entered by the user, where the code is provided via text message “SMS” to the user's mobile device by the service provider once an account has been created via registration. Once the code is entered, as reflected by the screen of FIG. 8, registration is now securely completed, and the user may be directed to a screen configured to permit the user to begin sending funds, as reflected in FIG. 9, and discussed below

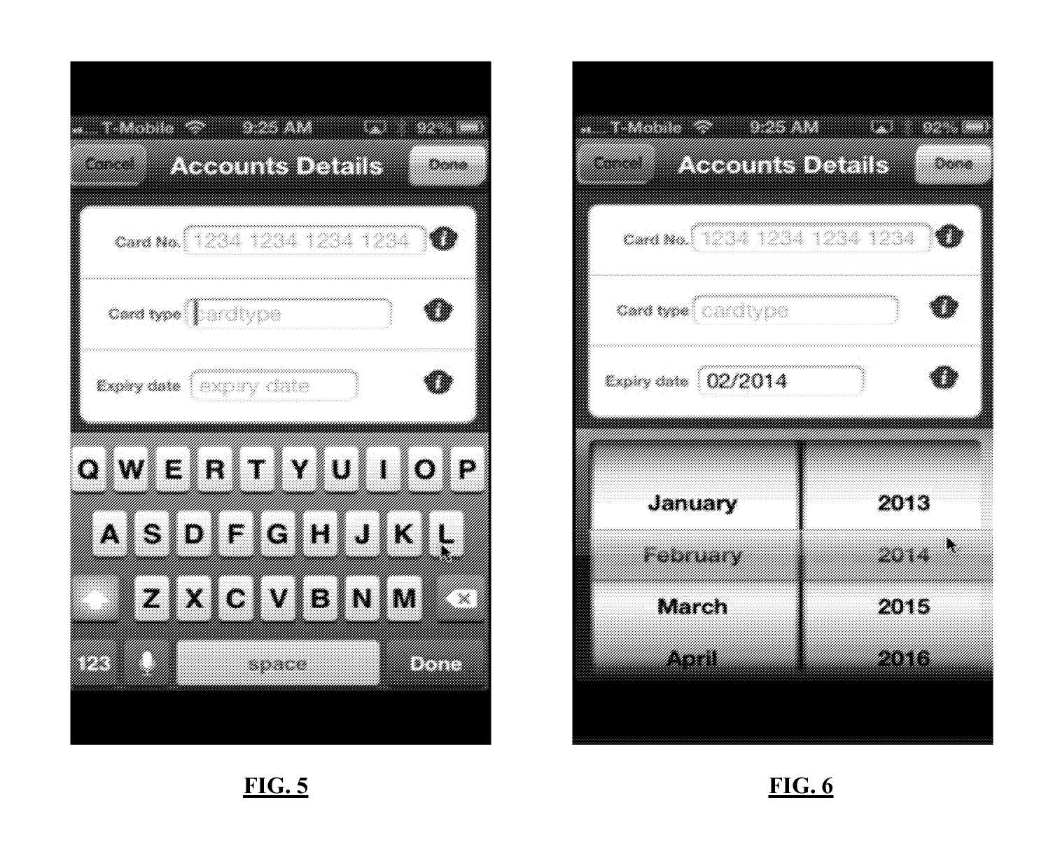

Returning to FIG. 3, embodiments of the inventive applications also permit a user to associate one or more credit cards with their personal fund-exchange account during the registration process. In that regard, for example, an icon entitled “Add Credit Card” may be provided, along with an information “i” icon, and a link (the “+” icon) to a window for entering information about the credit card, as shown in FIG. 3. The credit card may be associated with the personal fund-exchange account either during registration, or following registration as will be appreciated further below. Regardless, if the user is at the “Registration” screen of FIG. 3 and clicks on the “+” link next to the “Add Credit Card” icon, a screen will be displayed, such as the one by example in FIG. 4, with information to be provided by the user about the credit card that the user desires to register or associate with the personal fund-exchange account. The window may be entitled “Accounts Details”, for example, and permits a user to populate various fields, whereby a keyboard may pop up when the user directs a cursor to one field to be populated or touches the field with his finger or stylus, depending upon how the mobile device is configured to operate, as shown in FIG. 5, with additional information being provided as exemplified by the screen of FIG. 6. Once the credit card information is entered, the user may associate yet another credit card or simply complete the registration process to be directed to the “Registration complete!” screens of FIGS. 7 and, as discussed above.

Once registration is completed securely, the user is directed to for example to a “SendFunds” screen, such as that shown in FIG. 9. With such a screen, a plurality of menu items may be provided, as shown in FIG. 9 and several other of the screens illustrated in the figures, permitting a user to “SendFunds”, access their “Accounts”, or configure or reconfigure “Settings”, all of which are reflected across the bottom of the screen with the row of icons named appropriately. In the case of the screen of FIG. 9, the “SendFunds” icon is highlighted to reflect that that menu item is selected (in this example by default upon completion of registration).

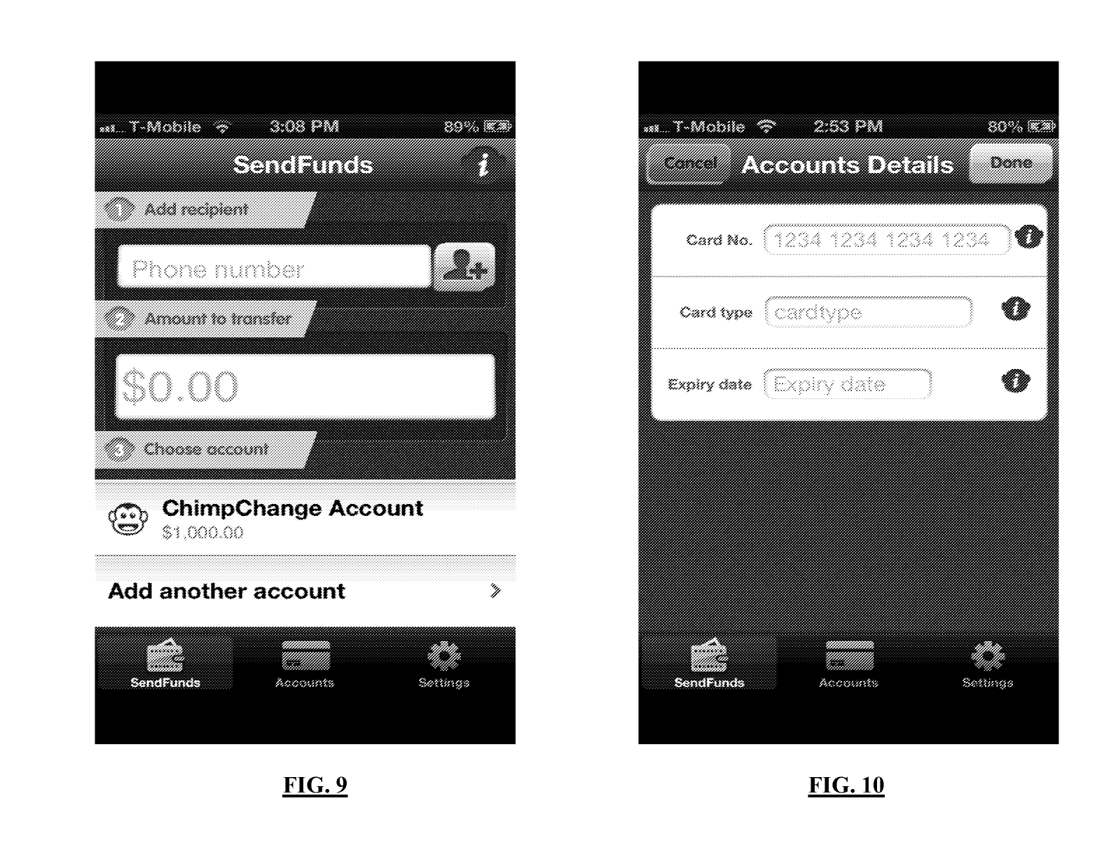

The screen of FIG. 9 permits yet another pathway for adding a first or additional credit card, following registration, where a link symbolized by the “Add another account” icon is provided above the lower menu items. If clicked, the screen of FIG. 10 may appear, for example, which looks almost the same as the Accounts Details screen of FIG. 4. The difference is that, with registration complete, and a personal fund-exchange account established, full functionality is accessible, as reflected by the plurality of menu item icons displayed at the bottom of the screen of FIG. 10, where no such icons exist in the screen of FIG. 4 during registration. The same or similar process may be followed for associating a credit card account with the personal fund-exchange of the application after registration as during registration; i.e., where the same or similar fields are to be populated by the user.

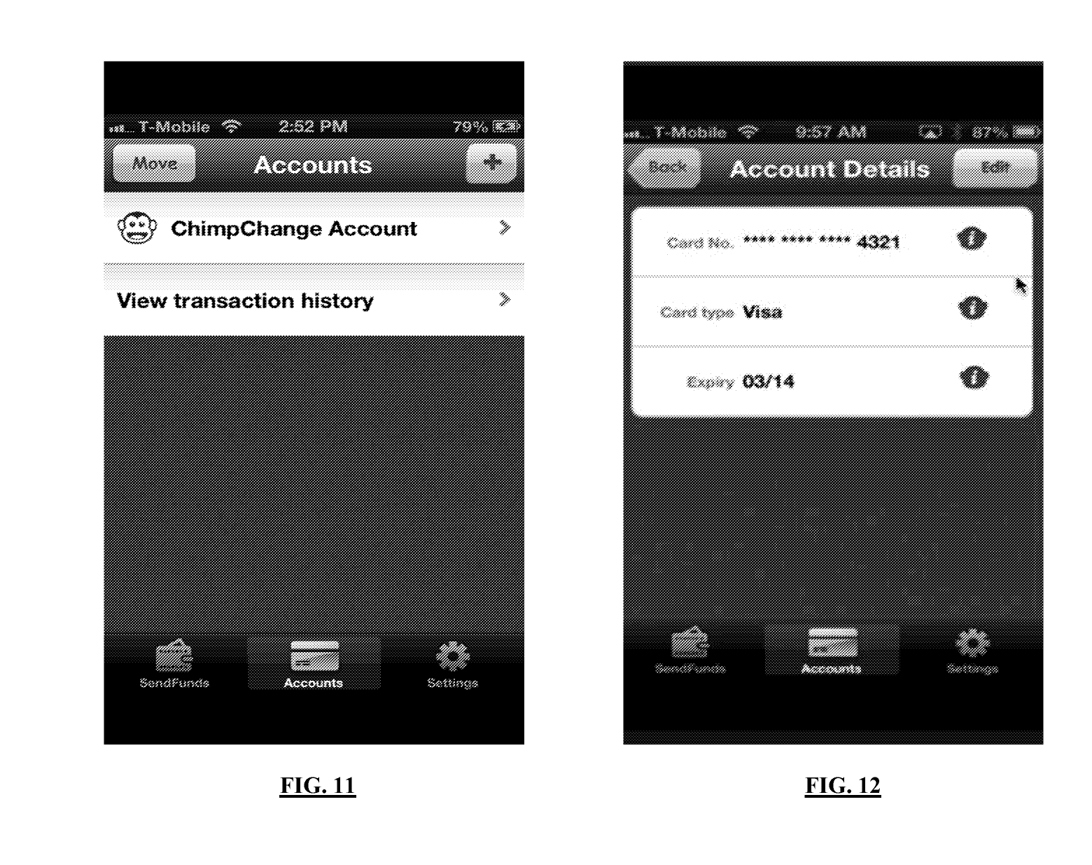

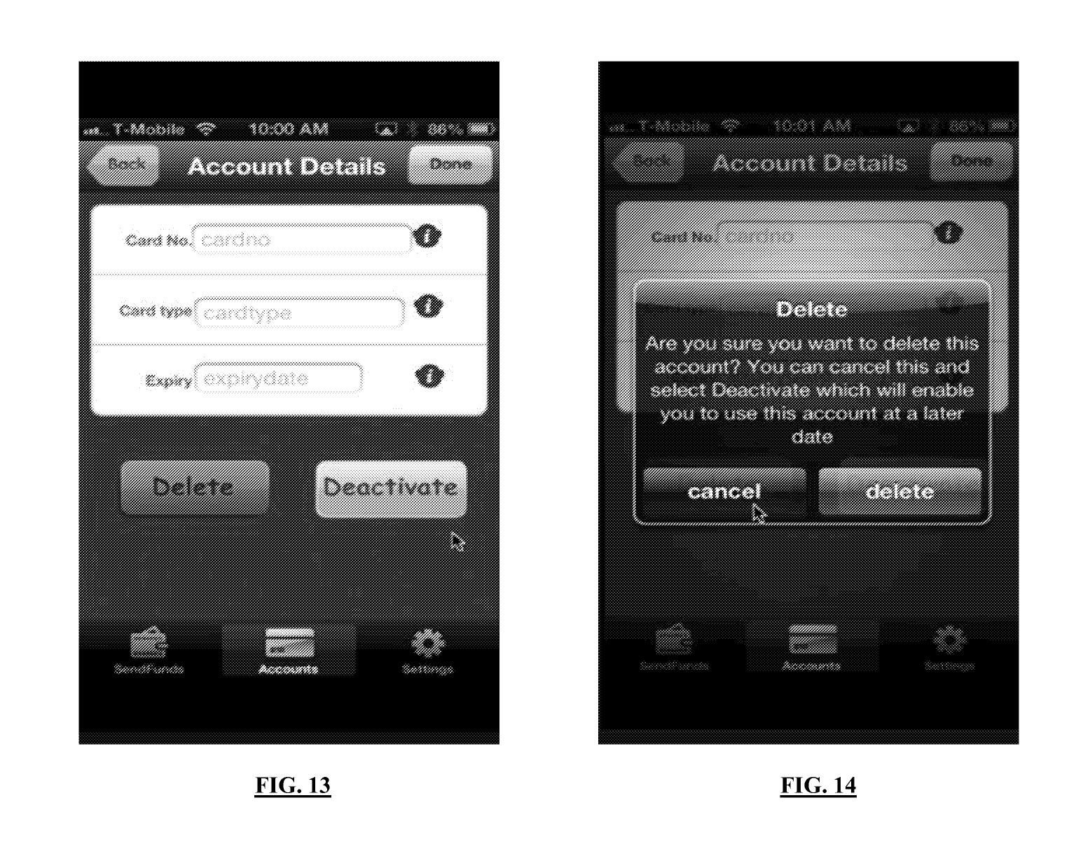

Referring to FIG. 11, if the user selects the menu icon “Accounts” at the bottom, a screen such as that shown will be displayed, providing line-item information about the user's accounts. Such information may include a line item identifying the personal fund-exchange account (entitled by example here “ChimpChange Account”), as well as credit card accounts that are associated with the personal account (although none are shown here in this example). Line item information may also include a link to the history of transactions for each account. If a credit card account has been associated, and the link is clicked, a screen such as that shown in FIG. 12 may appear, providing high level information about the credit card account. Preferably, edit functionality is provided by embodiments of the inventive application, permitting a user to edit the account information or, as reflected in FIG. 13, to delete or deactivate the an account. Appropriate configurations may be put into place, such as reflected in the screen of FIG. 14, depending upon the settings of the user, to verify any deletions before doing so, although such functionality is not critical to the application.

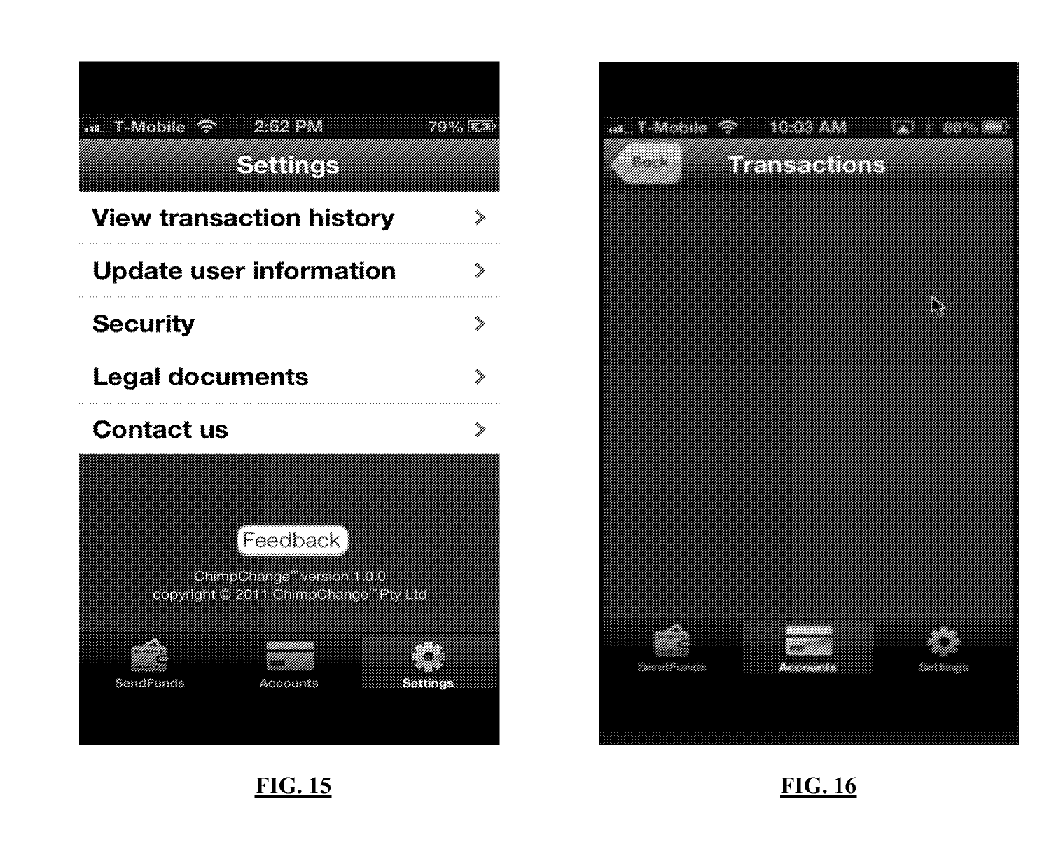

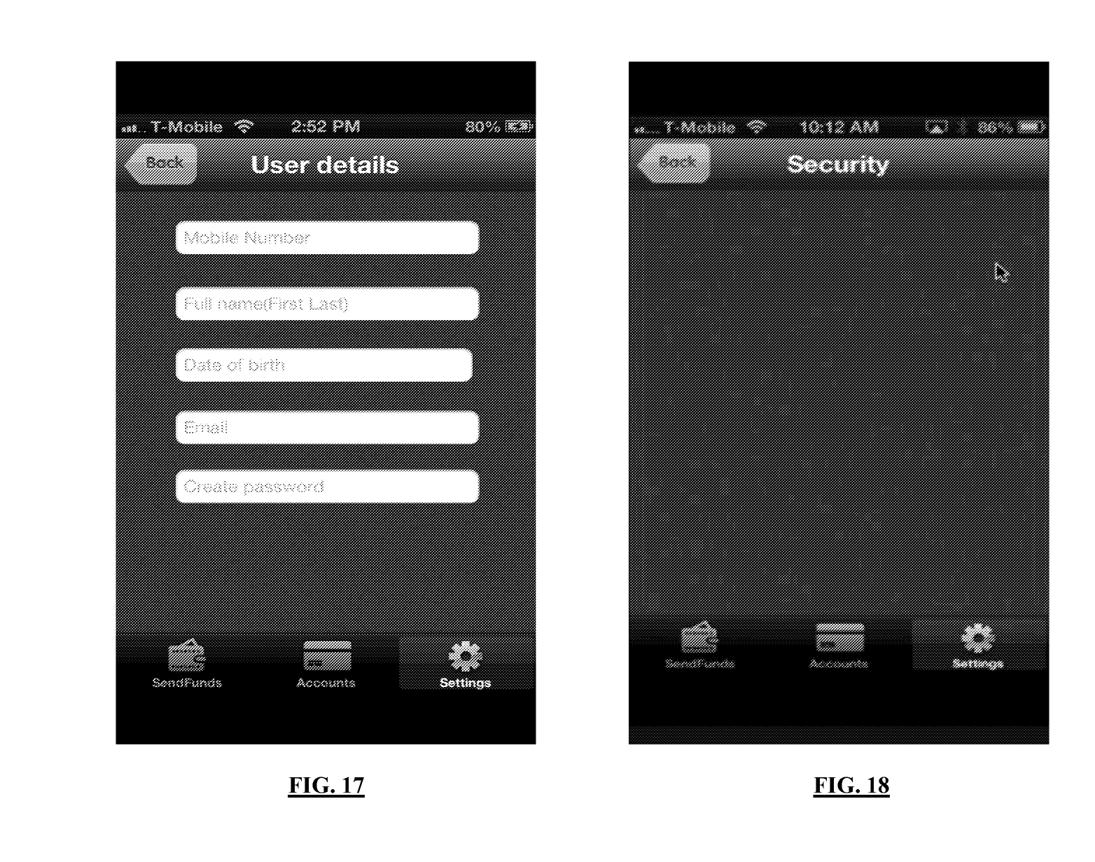

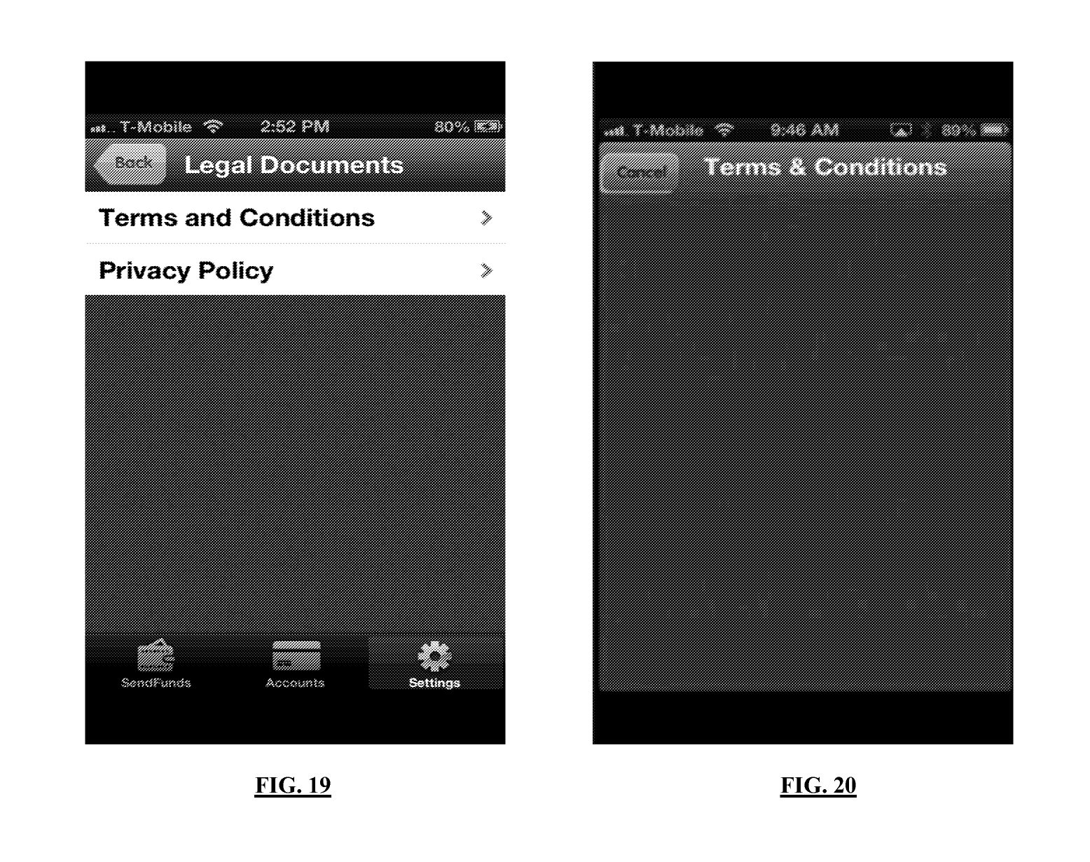

Turning to FIG. 15, several sub-menu items may be displayed upon a user's clicking on the “Settings” menu item icon, including “View transaction history”, “Update user information”, “Security”, “Legal Documents” and “Contact Us.” These are by example only, and other embodiments of the inventive applications described herein may provide more or less functionality in the settings configuration. In that regard, FIGS. 16 through 20 show examples of screens that may be displayed by clicking on the sub-menu links provided, although some of the screens are presently blank, such as the “Transactions” history log of FIG. 16, the “Security” page of FIG. 18, and the “Terms and Conditions” page of FIG. 20. Embodiments of the present application may vary considerable on the type of information and/or functionality provided in each of these sub-menu pathways, but are presented simply to show the types of user-friendly features that may be employed.

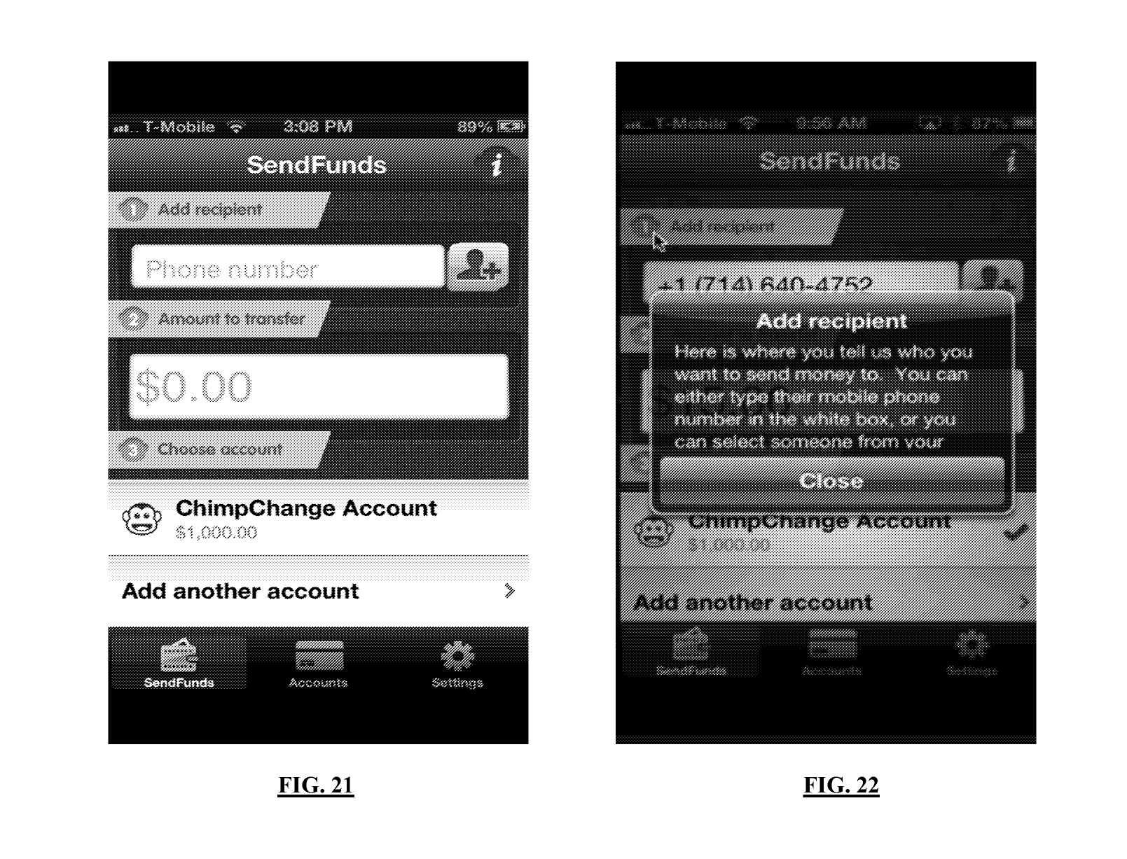

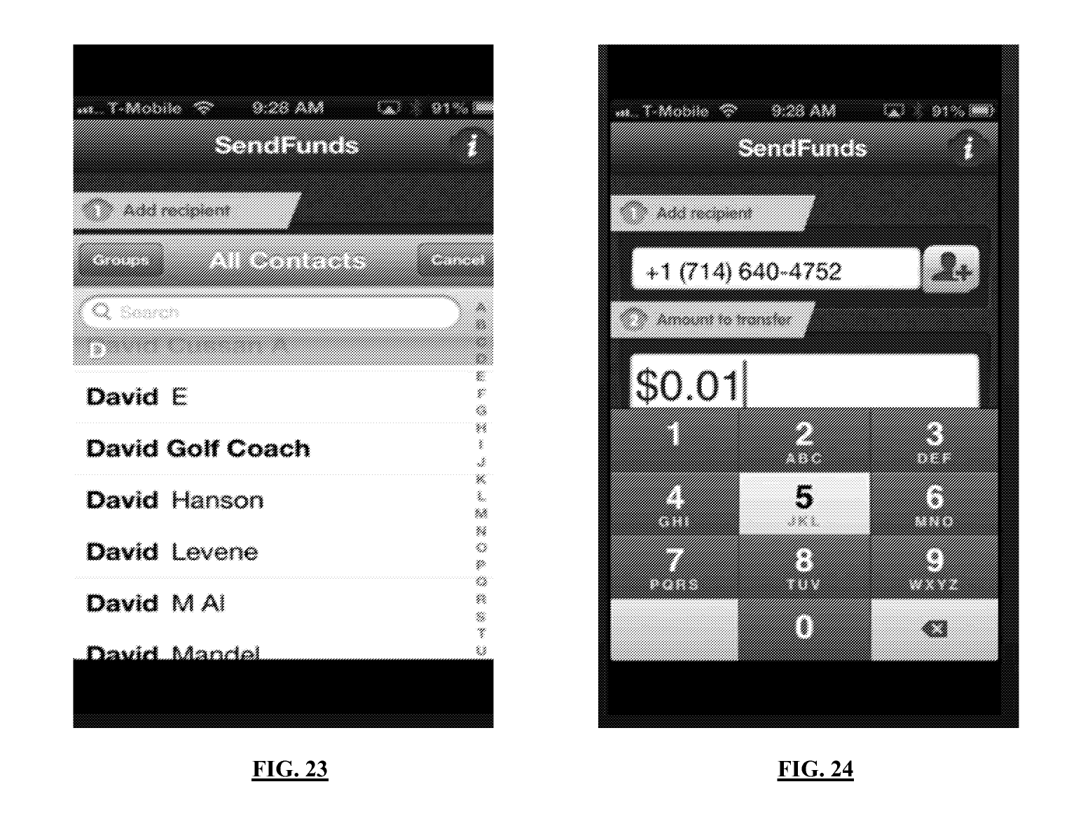

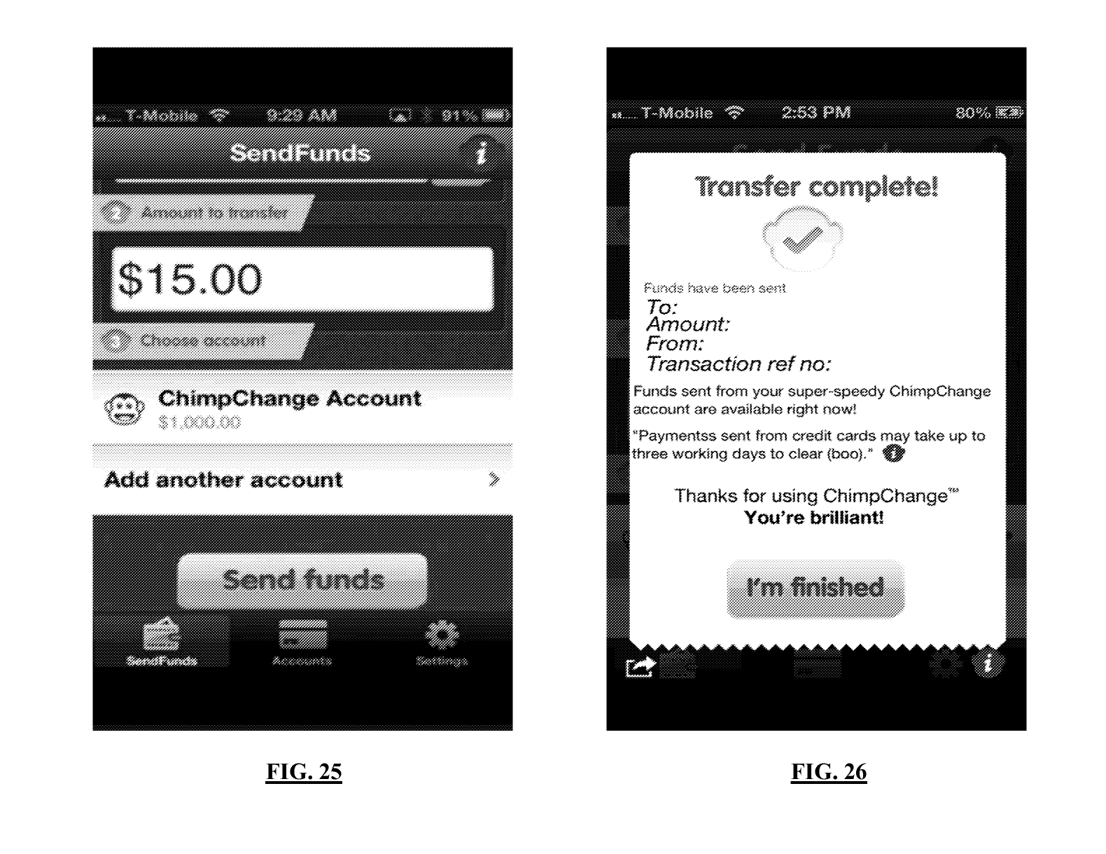

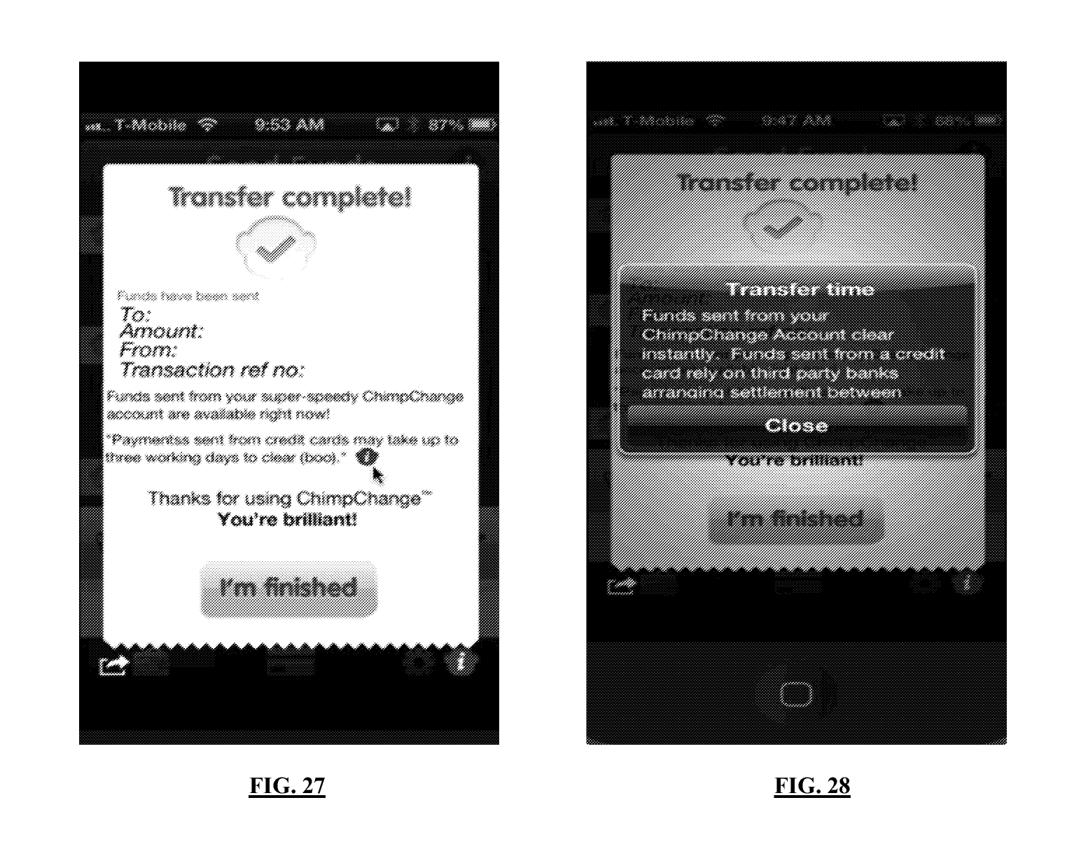

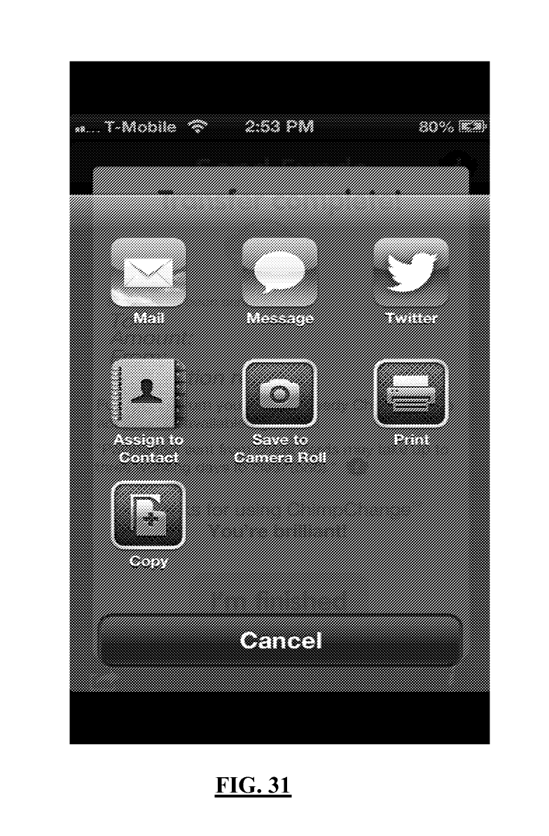

Referring to FIGS. 21 through 31, a series of screens are displayed by example only to show the functionality employed in at least some embodiments of the present fund-exchange application. As may be evident from the screens themselves, links and icons are provided to permit data input by the user regarding transfers of money that the user desires to make between his or her account and someone else's. As discussed above, informational icons may be peppered throughout the screens to assist the user in navigating the process of transferring funds, such as the information “i” icon of FIG. 21, or in merely clicking on the function icons themselves (e.g., “(1) Add recipient”, of FIG. 21, which may lead to the hover screen of FIG. 22). By entering the recipient to receive the funds, either from an existing contact list or a new contact being input, and a dollar amount, a transfer can be initiated. Importantly, however, certain embodiments of the inventive application described herein permit an exchange not only from the personal fund-exchange account established by the user during registration, but from one or another of a user's credit card account. For example, in the screen of FIG. 21, a link entitled “Add another account” provides the opportunity to add a credit card account, as discussed above in association with FIG. 9.

At least one benefit of certain embodiments of the inventive fund-exchange application is the ability to directly transfer funds from any account that the user sets up as being associated with the personal fund-exchange account. Thus, by setting up one or more additional accounts in association with the personal fund-exchange account, the user may optionally transfer funds directly from the associated account to the recipient without utilizing or going through the personal fund-exchange account. Indeed, a user may choose to never fund the personal fund-exchange account established during registration, and simply conduct transfers using the associated accounts.

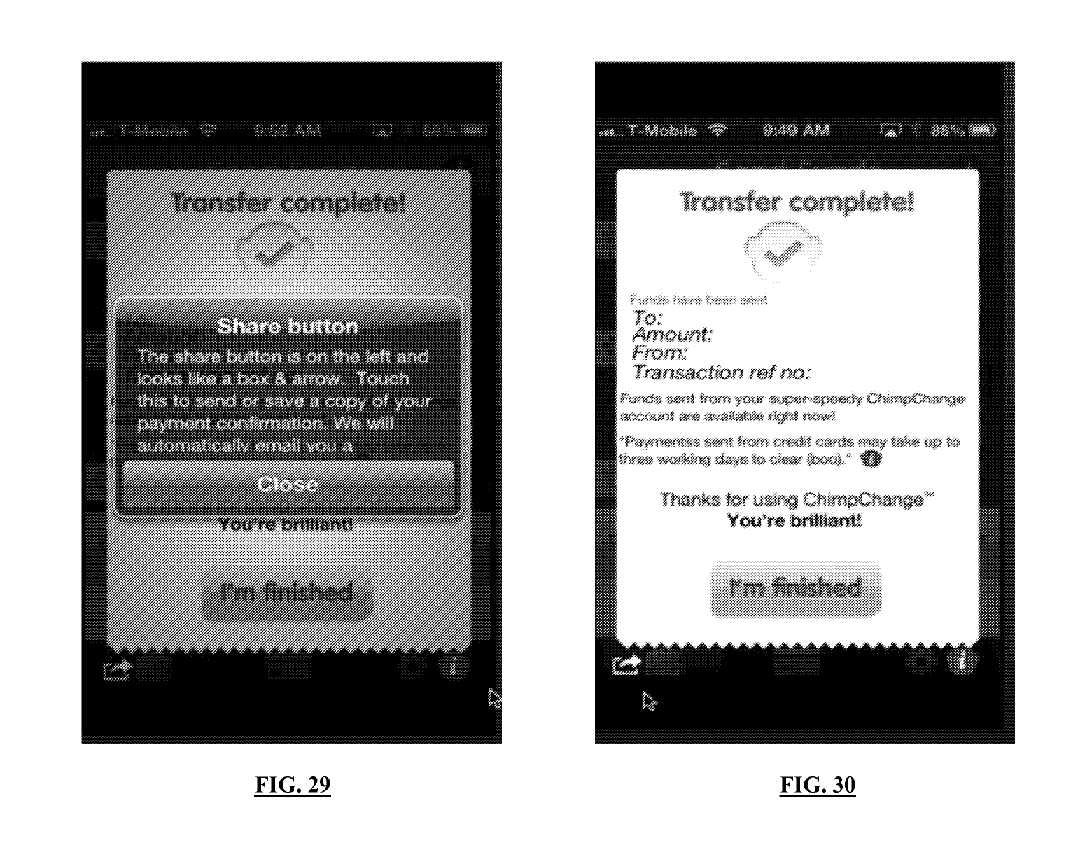

As shown in the screens of FIGS. 29 and 30, a “Share button” may be provided to permit the user to share information about the transferred funds to one or more of a number of destinations. In the example “Transfer complete!” screen of FIG. 29, the user's clicking on the information “i” icon causes a hover screen to appear describing the “Share button” feature and how to use it. In this case, the “Share button” is represented by an icon in the lower left of the screen showing a box & arrow. If the user clicks on the “Share button,” as shown in the screen of FIG. 30, the user is shown a menu of applications by which the user may share information about the transaction. The choice of applications may vary depending upon one embodiment or another, or depending upon the applications available on the user's mobile device, but essentially the applications reflect a variety of pathways by which the user may share information about the transfer. In some embodiments, the user may be permitted to take a snap shot of a report of the transaction details, or make a copy, or print the details, or send the details via email, text messaging, through a Twitter® account, Facebook® account, or the like.

It is also contemplated that the functionality described above in association with embodiments of a downloadable application may be provided in the form of software that may be installed on a desktop or laptop or tablet, or in the form of a web-based application accessible via the internet. In other words, for those users who want the flexibility to transfer funds both from a mobile device and from their computer, parallel functionality may be provided using the same fund-exchange account, whether registration was conducted on the mobile device or on the user's computer. Both the mobile device and the computer vehicles may be used to make transfers from the same accounts (i.e., the fund-exchange account or the associated credit cards). Or, a user may elect to only use a computer to conduct such transfers, either through installed software or through a web-based application. In any case, data may be stored on a computer hard drive or on the cloud, regardless of the vehicle employed by the user to register and conduct transfers.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system comprising an application that is either configured to be downloadable to a mobile device, configured as a web-based program accessible through the Internet, and/or configured as a software program installable on a computer, the system further configured to permit the exchange of money by a user between a user account and an account outside the system, the system comprising:
means for permitting a user to establish the user account via a registration process, where the user account is configured to be dynamically funded at select or periodic intervals by the user from one of a number of possible funding sources;
means for associating one or more separate accounts with the registered user account; and
means for directing a transfer of money to an outside account either directly from the registered user account or directly from one or more of the separate accounts, permitting the user to by-pass the registered user account if so desired.

2. The system of claim 1, wherein the system comprises only a downloadable application configured to be downloaded and fully controlled from a user's mobile device to permit full functionality without the need for the user to use a separate computer-based software program or web-based application.

3. The system of claim 1, wherein the system comprises only a web-based program accessible by users through the Internet.

4. The system of claim 1, wherein the separate account comprises one of the following types of accounts: a credit card, a debit card, a bank account, an investment account, or an operator billing account.

5. The system of claim 1, wherein the registered user account is automatically associated with a 16-digit debit card generated by the system and sent to the user so that the user may use the debit card to pay for things based upon the funds available in the system account.

6. The system of claim 5, further comprising means for tailoring the graphics of the debit card by adding one or more photos and other personal information.

7. The system of claim 1, further comprising means for communicating with the holder of the outside account that an exchange of money has been made, the method of communication comprising one of a number of digital formats, including text, email or the like.

8. A method of exchanging of money between a user account and an outside account, the method comprising:
permitting a user to establish the user account via a registration process, where the user account is configured to be dynamically funded at select or periodic intervals by the user from one of a number of possible funding sources;
associating one or more separate accounts with the registered user account; and
directing a transfer of money to an outside account either directly from the registered user account or directly from one or more of the separate accounts, permitting the user to by-pass the registered user account if so desired.

9. The method of claim 8, wherein the registration, association of one or more separate accounts, and the directing of a transfer of money are entirely performed on the user's mobile device.
